(19) United States
(12) Patent Application Publication
(10) Pub. No.: US 2001/0043446 A1
(43) Pub. Date: Nov. 22, 2001

(54) METHOD AND SYSTEM FOR PROVIDING HEAT CONDUCTION AND ELECTROSTATIC DISCHARGE PROTECTION FOR MAGNETORESISTIVE HEADS

(76) Inventors: IRMELA C. BARLOW, LOS ALTOS, CA (US); CHUNG F. LAM, SAN JOSE, CA (US)

Correspondence Address: JOSEPH A SAWYER, SAWYER & ASSOCIATES, POST OFFICE BOX 51418, PALO ALTO, CA, 94303

(21) Appl. No.: 09/250,989

(22) Filed: Feb. 16, 1999

(51) Int. Cl. G11B 5/39

(52) U.S. Cl. 360/319; 360/323

(57) ABSTRACT

A system and method for providing a magnetoresistive head is disclosed. The magnetoresistive head includes a first shield, a second shield, a magnetoresistive element, a first gap, and a second gap. The first gap is for insulating the magnetoresistive element from the first shield. The second gap is for insulating the magnetoresistive element from the first shield. The method and system include providing a heat conduction path coupled to the first shield and to the second shield. Heat may be transferred from the first shield and from the second shield via the heat conduction path.

### FIELD OF THE INVENTION

The present invention relates to magnetoresistive heads and more particularly to a method and system for reducing the working temperature of magnetoresistive heads.

### BACKGROUND OF THE INVENTION

Conventional magnetoresistive (MR) heads are used to read data on a recording media. The MR head includes a MR element surrounded by a pair of shields. The MR element is separated and electrically insulated from the shields by a pair of gaps. The resistance of the MR element is sensitive to the magnetization of the MR element and, therefore, the field applied to the MR element by bits in the recording media.

In order to read the data, current is passed through the MR element. This current causes power to be dissipated by the MR element. The power dissipated by the MR element generates heat. This heat raises the working temperature of the MR head. The increase in temperature of the MR head adversely affects the lifetime of the MR head.

Electrostatic discharge (ESD) may also shorten the lifetime of the MR head. During operation, the shields may become charged. For example, if the MR head contacts the recording media, tribo-charging may occur. A charge on the shields may jump to the MR element. This charge may damage or destroy the MR element. This drastically shortens the lifetime of the MR head.

Accordingly, what is needed is a system and method for increasing the lifetime of the MR head. The present invention addresses such a need.

### SUMMARY OF THE INVENTION

The present invention provides a method and system for providing a magnetoresistive head. The magnetoresistive head includes a first shield, a second shield, a magnetoresistive element, a first gap, and a second gap. The first gap is for insulating the magnetoresistive element from the first shield. The second gap is for insulating the magnetoresistive element from the first shield. The method and system comprise providing a heat conduction path coupled to the first shield and to the second shield. Heat may be transferred from the first shield and from the second shield via the heat conduction path.

According to the system and method disclosed herein, the present invention allows heat to be transferred from the first and second shield, thereby lowering the working temperature of the magnetoresistive head increasing overall system lifetime.

### BRIEF DESCRIPTION OF THE DRAWINGS

FIG. 1 is a block diagram of a conventional magnetoresistive head.

FIG. 2 is a flow chart depicting a method for providing a magnetoresistive head in accordance with the present invention.

FIG. 3 is a block diagram of one embodiment of a magnetoresistive head in accordance with the present invention.

FIG. 4 is a block diagram of a second embodiment of a magnetoresistive head in accordance with the present invention.

FIG. 5 is a block diagram of a third embodiment of a magnetoresistive head in accordance with the present invention.

### DETAILED DESCRIPTION OF THE INVENTION

The present invention relates to an improvement in magnetoresistive heads. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

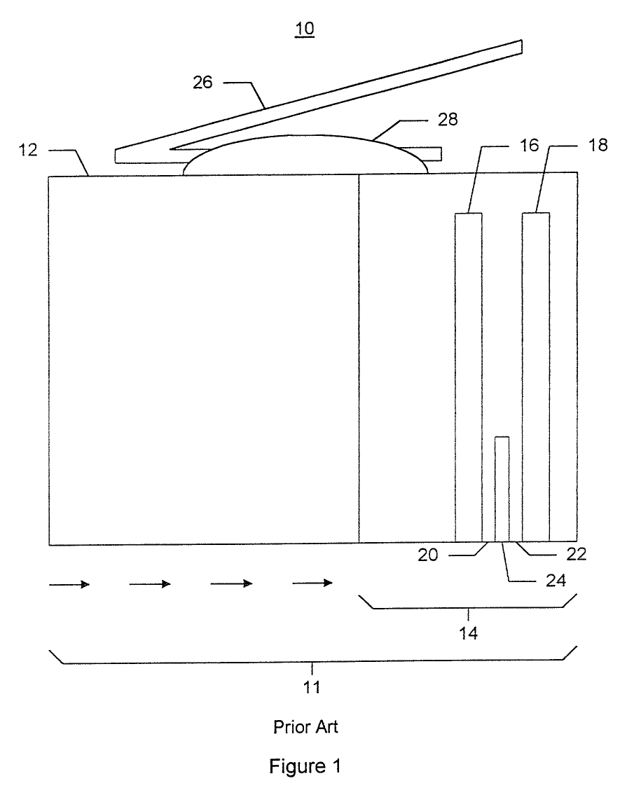

FIG. 1 is a block diagram of a conventional magnetoresistive head 10. The head 10 includes a body 11. The body includes a conductive portion 12 and an insulating portion 14. The conductive portion 12 is typically alumina titanium carbide. The insulating portion 14 is typically alumina. The body 11 is attached to a flexure 26 using epoxy 28. Typically, the flexure 26 is made of stainless steel and the epoxy 28 is conductive epoxy. The head 10 further includes a first shield 16 and a second shield 18. Between the first shield 16 and a second shield 18 is a magnetoresistance (“MR”) element 24. The MR element 24 may be a giant magnetoresistance (GMR) element or an anisotropic magnetoresistance (AMR) element. The MR element 24 is electrically isolated from the first shield 16 and the second shield 18 by a first gap 20 and a second gap 22, respectively. Current is carried to and from the MR element 24 by leads, not shown.

Although the MR head 10 functions, one of ordinary skill in the art will readily realize that the lifetime of the MR head 10 may be relatively short. During operation, a current I is provided to the MR element 24 relatively continuously. The MR element 24 also has a resistance R. The power dissipated by the MR element 24 during operation is I²R. heat equal to I²R is generated relatively continuously by the MR element 24. The MR element 24 is relatively small in comparison to and relatively close to the first shield 16 and the second shield 18. Consequently, heat generated by the MR element 24 is also transferred to the first shield 16 and the second shield 18. However, the first shield 16 and the second shield 18 are electrically and thermally isolated from the remainder of the MR body 11. Thus, the heat generated by the MR element 24 remains in the area of the first shield 16, the second shield 18, and the MR element 24.

The heat generated by the MR element 24 causes the area of the first shield 16, the second shield 18, and the MR element 24 to increase in temperature. During operation, the MR head 10 also flies over the surface of a recording media (not shown). The resulting air flow, depicted by arrows in FIG. 1, cools the MR head 10 slightly. Thus, during operation the MR head 10 in the region of the MR element 24 reaches an equilibrium temperature as the heat generated by the MR element 24 is balanced by the cooling action of the air flow. This equilibrium temperature, called the working temperature, is higher than the ambient temperature. It has been estimated that the working temperature of the conventional MR head 10 is on the order of one hundred degrees Centigrade.

One of ordinary skill in the art will readily realize that the lifetime of the MR head 10 is closely related to the working temperature of the MR head 10. The higher the working temperature, the shorter the lifetime of the MR head 10. As discussed above, the MR head 10 has. a relatively high working temperature. Thus, the lifetime of the MR head 10 may be relatively short.

One of ordinary skill in the art will also realize that electrostatic discharge (ESD) may also shorten the lifetime of the MR head 10. The MR element 24, the first shield 16, and the second shield 18 are electrically isolated from the remainder of the head 10. It is possible for any of these elements to acquire a charge. When the first shield 16 or the second shield 18 acquires a charge, the voltage of the first shield 16 or the second shield 18 may be very high. The voltage of the MR element 24 may be relatively low even though current is passing through the MR element 24. The charge may then jump to the MR element 24. When the charge jumps to the MR element 24, the charge may destroy the MR element 24. The MR head 10 may no longer function. Thus, electrostatic discharge may also shorten the life of the MR head 10.

The present invention provides a method and system for providing a magnetoresistive head. The magnetoresistive head includes a first shield, a second shield, a magnetoresistive element, a first gap, and a second gap. The first gap is for insulating the magnetoresistive element from the first shield. The second gap is for insulating the magnetoresistive element from the first shield. The method and system comprise providing a heat conduction path coupled to the first shield and to the second shield. Heat may be transferred from the first shield and from the second shield via the heat conduction path.

The present invention will be described in terms of a magnetoresistive head having particular heat conduction paths formed of particular materials. However, one of ordinary skill in the art will readily recognize that this method and system will operate effectively for other types of materials and different heat conduction paths.

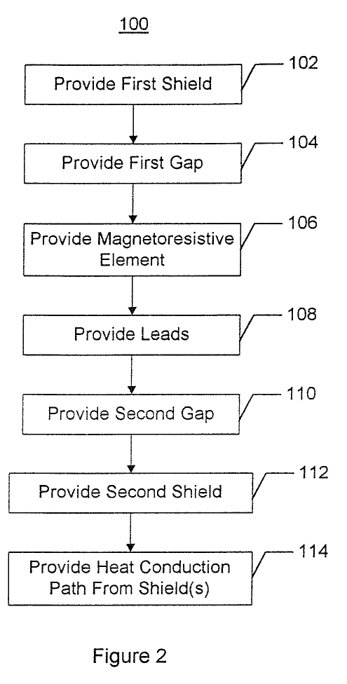

To more particularly illustrate the method and system in accordance with the present invention, refer now to FIG. 2 depicting a flow chart of a method 100 for providing a MR head in accordance with the present invention. For the purposes of clarity, only certain steps are depicted in the method 100. A first shield and a first gap are provided, via steps 102 and 104, respectively. A MR element is then provided, via step 106. In a preferred embodiment, step 106 includes providing a spin valve structure. Leads are provided to the MR element, via step 108. In one embodiment, step 108 includes providing a magnetic bias for the MR element provided in step 106. A second gap and a second shield are provided in steps 110 and 112, respectively. A heat conduction path is provided from the first shield, the second shield, or both shields, via step 114. In a preferred embodiment, step 114 includes grounding the first and second shields.

Because a heat conduction path is provided, heat generated by the MR element during operation is conducted away from the first and/or second shields. Thus, the working temperature of the MR head is reduced and the lifetime extended. In addition, grounding the first and second shields reduces the probability that a charge will accumulate on the first or second shields and reduces the probability that a charge which does arise on the first or second shields will jump to the MR element. Thus, the probability that the MR element will be destroyed due to charging is reduced. The lifetime of the MR head is thereby extended.

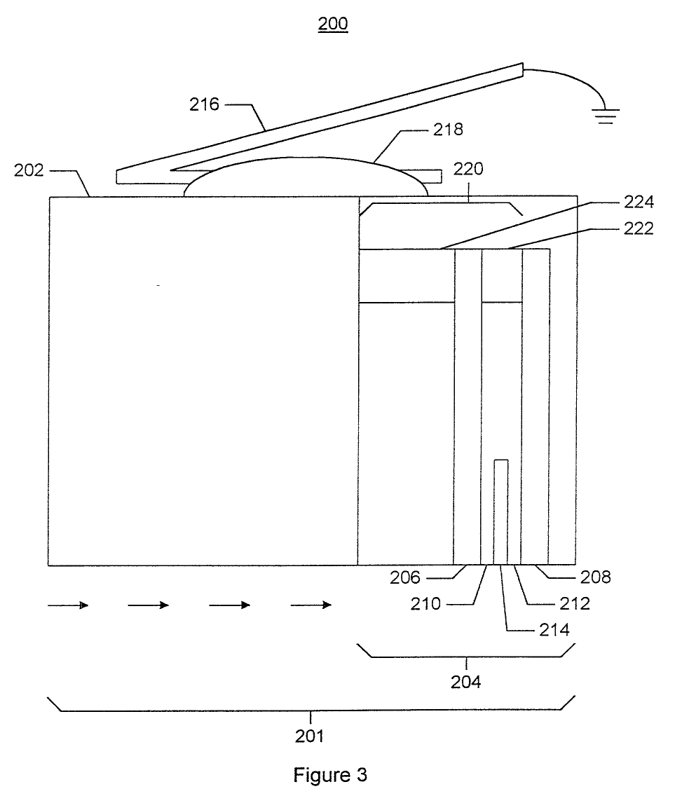

FIG. 3 depicts a preferred embodiment of a MR head 200 in accordance with the present invention. The MR head 200 includes a body 201 coupled to a suspension flexure 216 using epoxy 218. The suspension flexure is preferably stainless steel. The epoxy 218 is preferably conductive epoxy. The body 201 includes a conductive portion 202 and an insulating portion 204. The conductive portion 202 is preferably alumina titanium carbide, while the insulating portion 204 is preferably alumina. A first shield 206 and a second shield 208 surround a MR element 214. In a preferred embodiment, the MR element 214 is a GMR element such as a spin valve. The MR element 214 is insulated from the first shield 206 and the second shield 208 by a first gap 210 and a second gap 212, respectively. Leads (not shown) carry current to and from the MR element 214 during operation.

The MR head 200 also includes a heat conduction path 220. The heat conduction path 220 has two portions. A first portion 222 connects the second shield to the first shield. A second portion 224 connects the first shield to the conductive portion 202 of the body 201. Although the heat conduction path 220 is depicted as coupling the first shield 206 and the second shield 208, nothing prevents providing a heat conduction path for only the first shield 206 or only the second shield 208. For example, in an alternate embodiment, only the first shield 206 or only the second shield 208 might be connected to the conductive portion 202 of the body 201. In a preferred embodiment, however, the heat conduction path 220 is provided for both the first shield 206 and the second shield 208. In a preferred embodiment, the heat conduction path 220 includes an electrically conductive material, such as gold.

The presence of the heat conduction path 220 extends the lifetime of the MR head 200. Because the heat conduction path 220 is provided from the first shield 206 and the second shield 208, heat generated by the MR element 214 is transferred to the conductive portion 202 of the body 201. The conductive portion 202 of the body 201 is significantly larger than the MR element 214, the first shield 206, and the second shield 208. Thus, the body 201 can act as a heat sink.

Because heat is transferred to the body 201, the working temperature of the MR head 200 is lower than the conventional head 10 depicted in FIG. 1. Referring back to FIG. 3, the MR element 214 will still generate heat during operation due to the dissipation of power I²R, where I is the current through the MR element 214 and R is the resistance of the MR element 214. Heat generated by the MR element 214 is conducted to the first shield 206 and the second shield 208. If the first shield 206 and the second shield 208 were not connected to the heat conduction path 220, heat generated by the MR element 214 would remain in the area of the MR element 214, increasing the working temperature and reducing the lifetime of the MR head 200. In addition to air cooling, depicted by the arrows in FIG. 3, heat is transferred from the first shield 206 and the second shield 208 via the heat conduction path 220. When the heat generated by the MR element 214 reaches equilibrium with the heat transferred, the working temperature of the portion of the MR head 200 in the vicinity of the MR element 214 and shields 206 and 208 is reached. This working temperature of the MR head 200 may be significantly lower than the working temperature of the conventional MR head 10. It is expected that the working temperature of the MR head 200 may be five degrees Centigrade or more lower than the working temperature of the conventional MR head 10. The working temperature of a MR head is directly related to the lifetime of the MR head. Thus, the lifetime of the MR head 200 may be significantly longer than the conventional MR head. However, even if the working temperature of the MR head 200 is only slightly less than the working temperature of the conventional MR head 10, the lifetime of the MR head 200 will be extended.

As depicted in FIG. 3, the suspension flexure 216 is grounded. Consequently, the conductive portion 202 of the body 201 is grounded. The first shield 206 and the second shield 208 are, therefore, also grounded. During operation, a small voltage is applied to the MR element 214 in order to pass current through the MR element 214. Because the first shield 206 and the second shield 208 are grounded, the voltage of the first shield 206 and the second shield 208 are close to that of the MR element 214. Moreover, the first shield 206 and the second shield 208 are connected to a sink for charge (ground). The first shield 206 and/or the second shield 208 may acquire a charge, for example due to tribo-charging. Because the first shield 206 and the second shield 208 are grounded, the charge will probably not jump to the MR element 214. Consequently, the MR element 214 will be preserved and the lifetime of the MR head 200 extended.

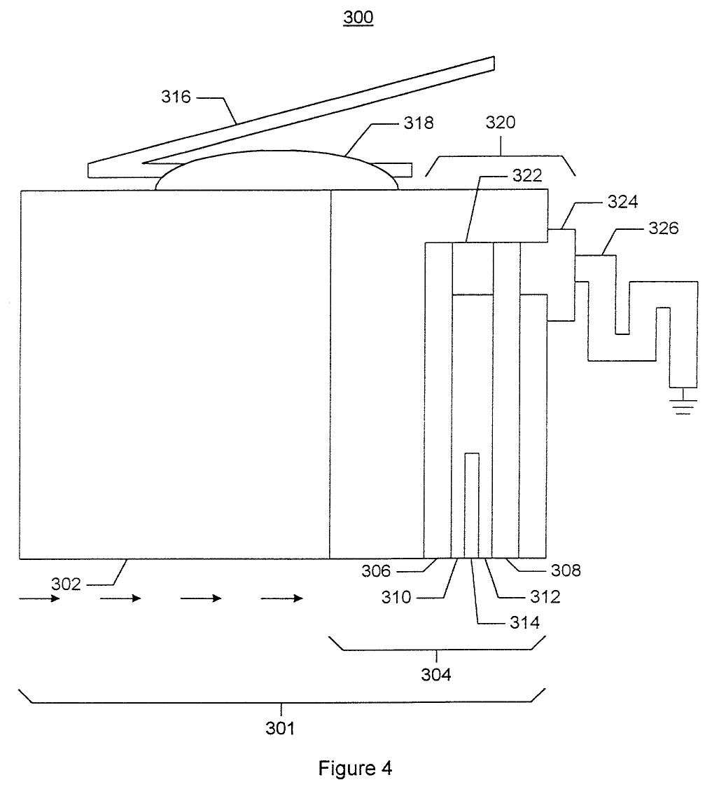

FIG. 4 depicts a second embodiment of a MR head 300 in accordance with the present invention. The MR head 300 includes a body 301 coupled to a suspension flexure 316 using epoxy 318. The suspension flexure is preferably stainless steel. The epoxy 318 is preferably conductive epoxy. The body 301 includes a conductive portion 302 and an insulating portion 304. The conductive portion 302 is preferably alumina titanium carbide, while the insulating portion 304 is preferably alununa. A first shield 306 and a second shield 308 surround a MR element 314. In a preferred embodiment, the MR element 314 is a GMR element such as a spin valve. The MR element 314 is insulated from the first shield 306 and the second shield 308 by a first gap 310 and a second gap 312, respectively. Leads (not shown) carry current to and from the MR element 314 during operation.

The MR head 300 also includes a heat conduction path 320. The heat conduction path 220 has two portions. A first portion 322 connects the second shield to the first shield. A second portion 324 connects the second shield to a lead 326. The second portion 324 includes a gold pad. The lead 326 is connected to ground. Although the heat conduction path 320 is depicted as coupling the first shield 306 and the second shield 308, nothing prevents providing a heat conduction path for only the first shield 306 or only the second shield 308. For example, in an alternate embodiment, only the first shield 306 or only the second shield 308 might be connected to the lead 326. In a preferred embodiment, however, the heat conduction path 320 is provided for both the first shield 306 and the second shield 308. The heat conduction path 320 is made from a conductive material, such as gold.

Connection to the lead 326 via the heat conduction path 320 extends the lifetime of the MR head 300. The lead 326 is typically significantly larger than the first shield 306, the second shield 308, and the MR element 314. The lead 326 can serve as a heat sink, similar to the body 201 in the MR head 200 depicted in FIG. 3. Referring back to FIG. 4, because the lead 326 serves as a heat sink, the working temperature of the MR head 300 may be lowered. The lifetime of the MR head 300 will, therefore, be extended. In addition, the lead 326 is grounded. Consequently, there is a lower probability that a charge acquired by the first shield 306 or the second shield 308 will jump to the MR element 314. Thus, the MR element 314 is less likely to be destroyed due to electrostatic discharge. The lifetime of the MR head 300 may thereby be extended.

FIG. 5 depicts an alternate embodiment of an MR head 400 in accordance with the present invention. The MR head 400 includes a body 401 coupled to a suspension flexure 416 using epoxy 418. The suspension flexure is preferably stainless steel. The epoxy 418 is preferably conductive epoxy. The body 401 includes a conductive portion 402 and an insulating portion 404. The conductive portion 402 is preferably alumina titanium carbide, while the insulating portion 404 is preferably alumina. A first shield 406 and a second shield 408 surround a MR element 414. In a preferred embodiment, the MR element 414 is a GMR element such as a spin valve. The MR element 414 is insulated from the first shield 406 and the second shield 408 by a first gap 410 and a second gap 412, respectively. Leads (not shown) carry current to and from the MR element 414 during operation.

The MR head 400 also includes a first heat conduction path 420 and a second heat conduction path 422. The first head conduction path 420 connects the first shield 406 to the conductive portion 402 of the body 401. The conductive portion 402 of the body 401 is connected to ground via the suspension flexure 416. The second head conduction path 422 connects the second shield to a lead 426. The second heat conduction path 422 includes a gold pad. The lead 426 is connected to ground. The first heat conduction path 420 and the second heat conduction path 422 are made from a conductive material, such as gold.

The heat conduction paths 420 and 422 extend the lifetime of the MR head 400. The lead 426 and the body 401 can serve as heat sinks. Therefore, the working temperature of the MR head 300 may be lowered and the lifetime of the MR head 300 extended. In addition, the lead 426 and the body 402 are grounded. There is, therefore, a lower probability that a charge acquired by the first shield 406 or the second shield 408 will jump to the MR element 414. Thus, the MR element 414 is less likely to be destroyed due to electrostatic discharge. The lifetime of the MR head 400 may thereby be extended.

A method and system has been disclosed for providing a magnetoresistive head having a heat conduction path for conducting heat from the first and second shields. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A magnetoresistive head including a first shield, a second shield, a magnetoresistive element, a first gap, and a second gap, the first gap for insulating the magnetoresistive element from the first shield, and the second gap for insulating the magnetoresistive element from the first shield, the magnetoresistive head comprising:
a heat conduction path coupled to the first shield and to the second shield;
wherein heat may be transferred from the first shield and from the second shield via the heat conduction path.

2. The magnetoresistive head of claim 1 wherein the heat conduction path further couples the first shield and the second shield to ground.

3. The magnetoresistive head of claim 1 further including a body; and
wherein the heat conduction path further couples the body to the first shield and the second shield, wherein heat may be transferred from the first shield and from the second shield to the body.

4. The magnetoresistive head of claim 3 wherein the body further includes a conductive portion, and wherein the heat conduction path further electrically couples the first shield and the second shield to the conductive portion of the body.

5. The magnetoresistive head of claim 4 wherein the conductive portion of the body is grounded, and wherein heat conduction path further grounds the first shield and the second shield.

6. The magnetoresistive head of claim 1 wherein the magnetoresistive element further includes a giant magnetoresistive element.

7. The magnetoresistive head of claim 1 further comprising:
at least one lead coupled to the heat conduction path and to ground; and
wherein heat may be transferred from the first shield and from the second shield to the at least one lead.

8. A magnetoresistive head including a first shield, a second shield, a magnetoresistive element, a first gap, and a second gap, the first gap for insulating the magnetoresistive element from the first shield, and the second gap for insulating the magnetoresistive element from the first shield, the magnetoresistive head comprising:
a first heat conduction path coupled to the first shield the first heat conduction path for transferring heat from the first shield;
wherein heat may be transferred from the first shield via the first heat conduction path.

9. The magnetoresistive head of claim 7 further comprising:
a second heat conduction path coupled to the second shield, the second heat conduction path for transferring heat from the second shield.

10. A method for providing a magnetoresistive head including a magnetoresistive element, the method comprising the steps of:
(a) providing a first shield;
(b) providing a second shield;
(c) providing a first gap for insulating the magnetoresistive element from the first shield, a portion of the first gap being located substantially between the magnetoresistive element and the first shield;
(d) providing a second gap for insulating the magnetoresistive element from a second shield, a portion of the second gap being located substantially between the magnetoresistive element and the second shield; and
(e) providing a second shield;
(f) providing a heat conduction path coupled to the first shield and to the second shield, the heat conduction path for transferring heat from the first shield and from the second shield.

11. The method of claim 10 wherein the step of providing the heat conduction path (f) further includes the step of:
(f1) coupling the first shield and the second shield to ground.

12. The method of claim 10 wherein the magnetoresistive head further includes a body having a conductive portion; and wherein the step of providing the heat conduction path (f) further includes the step of:
(f1) electrically coupling the conductive portion of the body to the first shield and the second shield, wherein heat may be transferred from the first shield and from the second shield to the body.

13. The method of claim 11 wherein the heat conduction path further electrically couples the first shield and the second shield to the conductive portion of the body.

14. The method head of claim 13 wherein the conductive portion of the body is grounded, and wherein the heat conduction path further allows the first shield and the second shield to be grounded.

15. The method of claim 10 wherein the magnetoresistive element further includes a giant magnetoresistive element.

16. The method of claim 10 further comprising the steps of:
(g) providing at least one lead coupled to the heat conduction path and to ground, the at least one lead for transferring heat from the first shield and from the second shield to the at least one lead.

17. A method for providing magnetoresistive head including a magnetoresistive element, the method comprising the steps of:
(a) providing a first shield;
(b) providing a first gap for insulating the magnetoresistive element from the first shield, a portion of the first gap being located substantially between the magnetoresistive element and the first shield;
(c) providing a second shield;
(d) providing a second gap for insulating the magnetoresistive element from the second shield, a portion of the second gap being located substantially between the magnetoresistive element and the second shield; and
(e) providing a first heat conduction path coupled to the first shield, the first heat conduction path for transferring heat from the first shield; and.

18. The method of claim 17 wherein the step of providing the first heat conduction path (e) further includes the step of:
(f1) coupling the first shield to ground.

19. The method of claim 17 further comprising the steps of:
(f) providing a second heat conduction path coupled to the second shield, the second heat conduction path for transferring heat from the second shield.
